(19) United States
(12) Patent Application Publication
(10) Pub. No.: US 2006/0103092 A1
(43) Pub. Date: May 18, 2006

(54) Universal mobile base

(76) Inventors: Mark Strahler, Pittsburgh, PA (US); Chuck Baird, Verana, PA (US); Frederick Barbieri, White Oak, PA (US); Scott Cox, Kittanning, PA (US)

Correspondence Address: THE BLACK & DECKER CORPORATION, 701 EAST JOPPA ROAD, TW199, TOWSON, MD, 21286, US

(21) Appl. No.: 11/077,983

(22) Filed: Mar. 11, 2005

Related U.S. Application Data
(60) Provisional application No. 60/552,117, filed on Mar. 11, 2004.

(51) Int. Cl. B62B 5/00

(52) U.S. Cl. 280/79.11

(57) ABSTRACT

A mobile base assembly for receiving an object includes a generally planar base member, a plurality of base supports and at least one wheel member connected with each base support included in the plurality of base supports for transporting the mobile base assembly. Each base support of the plurality of base supports includes a receiver member defining a single slot for receiving at least a portion of the base member. The dimensions of the base member are approximate to footprint dimensions of an object being supported by the mobile base assembly.

### CROSS-REFERENCE TO RELATED APPLICATIONS

The present application claims priority under 35 U.S.C. § 119(e) to U.S. Provisional Application No. 60/552,117 entitled: Universal Base filed Mar. 11, 2004, which is hereby incorporated by reference in its entirety.

### FIELD OF THE INVENTION

The present invention generally relates to the field of material handling, and particularly, to a universal mobile base for use with various devices, such as large power tools and equipment.

### BACKGROUND OF THE INVENTION

Mobile bases are typically employed to allow a user to more easily transport and relocate large power tools, such as table saws or band saws. However, a number of current mobile bases are only configured for power tools having a specific “foot print”, thereby limiting their usefulness. Other current mobile bases are constructed with adjustable steel bars for accommodating power tools having differently-sized foot prints. Unfortunately, such mobile bases may still accommodate only a limited range of footprints, may be difficult to assemble and may be costly to manufacture.

Therefore it would be desirable to provide a mobile base which increases the capability of a user to customize the size of the mobile base, but is cost-effective and promotes easier assembly.

### SUMMARY OF THE INVENTION

Accordingly, a first aspect of the present invention is directed to a mobile base assembly for receiving an object including a generally planar base member; a plurality of base supports, each base support of the plurality of base supports including a receiver member defining a single slot for receiving at least a portion of the base member; and at least one wheel member connected with each base support included in the plurality of base supports for transporting the universal mobile base assembly, wherein dimensions of the base member are approximate to footprint dimensions of an object being supported by the mobile base assembly.

An additional aspect of the present invention is directed to an unassembled kit including those parts necessary to provide a mobile base assembly as described above. The kit may exclude the base member and the user would supply the base member in the form of, for example, a sheet of plywood, in dimensions necessary to assemble the kit into a mobile base of a predetermined size and shape.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an isometric illustration of a universal mobile base assembly in accordance with an exemplary embodiment of the present invention;

FIG. 2 is an exploded view of a universal mobile base assembly in accordance with an exemplary embodiment of the present invention;

FIG. 3 is a partial side view showing the foot pedal of a universal mobile base assembly in accordance with an exemplary embodiment of the present invention, the foot pedal positioned in a first position; and

FIG. 4 is a partial side view showing the foot pedal of a universal mobile base assembly in accordance with an exemplary embodiment of the present invention, the foot pedal positioned in a second position.

### DETAILED DESCRIPTION OF THE INVENTION

Reference will now be made in detail to the presently preferred embodiments of the invention, examples of which are illustrated in the accompanying drawings.

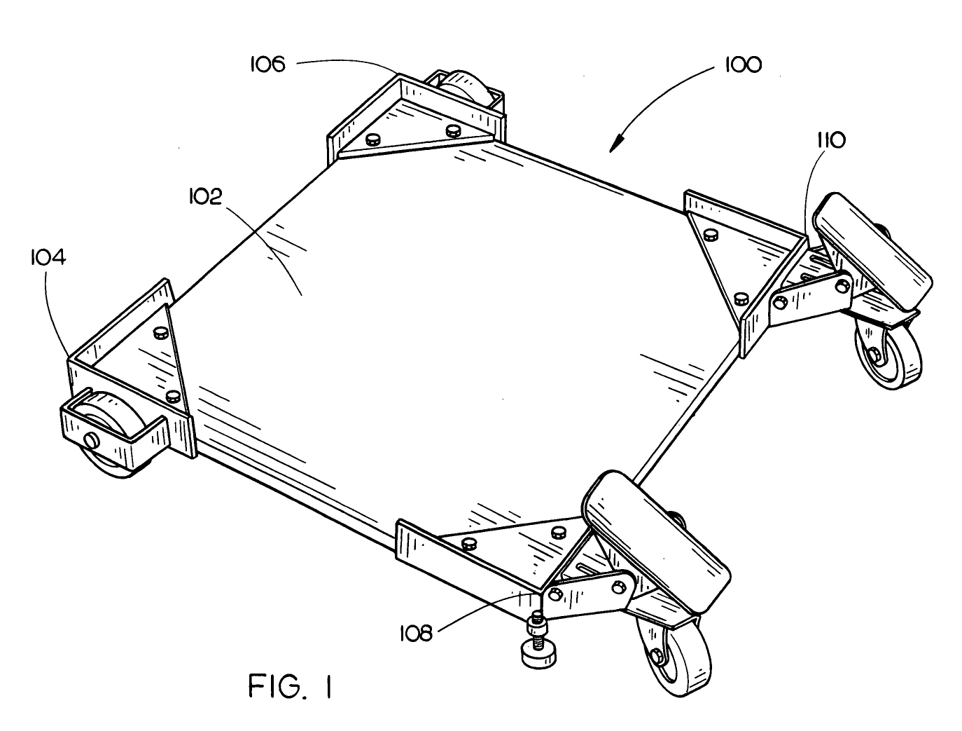

Referring generally now to FIGS. 1 through 4, exemplary embodiments of the present invention are shown.

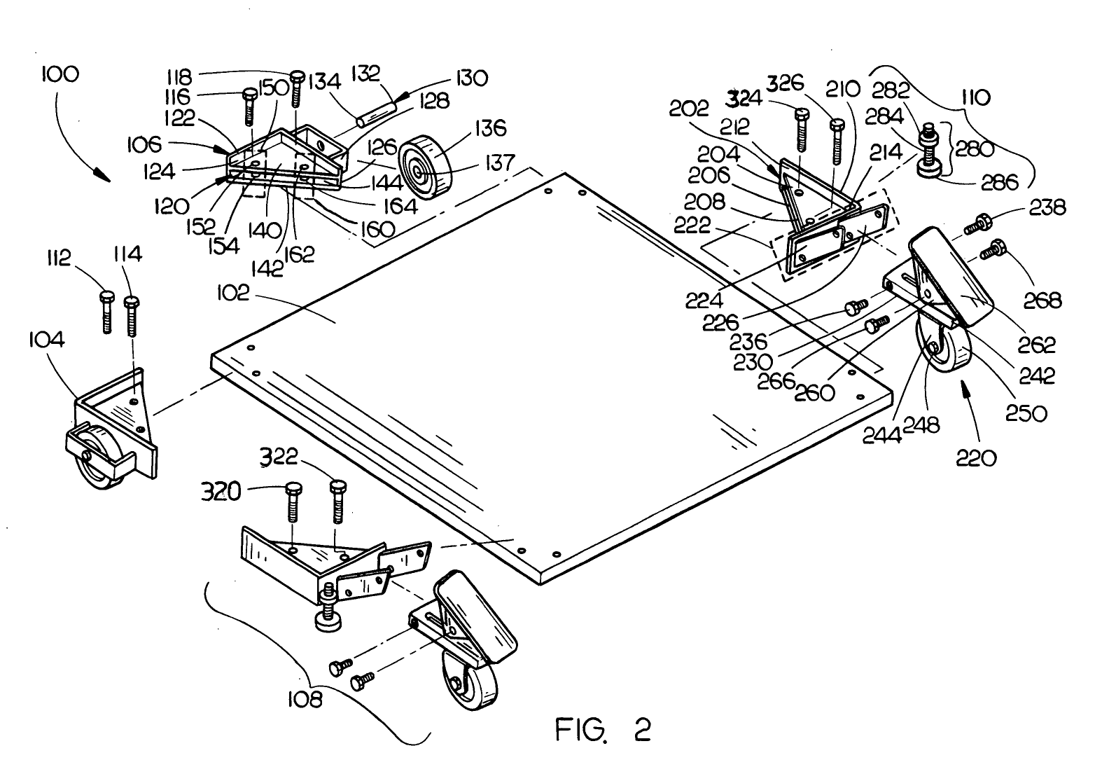

In a present embodiment, a universal mobile base assembly 100 includes a base member 102 coupled with a plurality of base supports. In a preferred embodiment, as shown in FIGS. 1 and 2, the base member 102 is coupled with a first base support 104, a second base support 106, a third base support 108 and a fourth base support 110. In the illustrated embodiment, the first through fourth base supports are coupled with the base member 102 via the use of a first fastener 112, a second fastener 114, a third fastener 116, a fourth fastener 118, a fifth fastener 320, a sixth fastener 322, a seventh fastener 324 and an eighth fastener 326. In additional embodiments, varying numbers of fasteners may be used to couple the base member 102 with the base supports. In further embodiments, the base member 102 may be coupled with the base supports in various other manners, such as by gluing.

In the illustrated embodiment, the base supports 104 through 110 are substantially similar. Therefore, the following description of the second base support 106 is intended to encompass and serve as a description for base supports 104, 108 and 110.

In an exemplary embodiment, the base support 106 includes a receiver member 120 connected with a first side 124 of a mount 122. The receiver member 120 includes a first side 140 and a second side 142 which define a slot 144. The slot 144 is configured to accept at least a portion of the base member 102. In the preferred embodiment, the mount 122 of the base support 106 forms a ninety (90) degree-angle and the slot 144 of the receiver member 120 is configured to receive a corner of a generally square-shaped base member 102. In further embodiments, the mount 122, the receiver member 120 and the slot 144 may be variously configured for receiving at least a portion of a base member 102 having various sizes and shapes, such as a generally rectangular-shaped base member 102. In a further example, the mount 122, the receiver member 120 and the slot 144 may form a generally U-shaped base support 106 configured for receiving an edge portion of a base member 102. In additional embodiments, the size of the slot 144 defined by the first side 140 and second side 142 of the receiver member 120 may be variously configured to accommodate base members 102 of varying thickness. For example, the slot 144 may be enabled to receive a portion of a base member 102 having a thickness of up to and including one inch. Further, the base assembly 100 may allow for the use of one or more shims to assist in securing the base member 102 within the receiver member 120 when the thickness of the base member 102 is less than the maximum thickness the slot 140 is configured to accept.

In the illustrated embodiment, the first side 140 of the receiver member 120 is configured for supporting at least a portion of an object being transported by the base assembly 100. For example, the first side of the receiver member 120 may be configured to support a foot member of a table saw leg. In a present embodiment, the mount 122 of the base support 106 forms a lip extending in a direction perpendicular to the receiver member 120. The lip of the mount 122 is for preventing an object being supported by the first side of the receiver member 120 from sliding off of the base assembly 100 during transport. In further embodiments, the base support 106 is configured so that it may be inverted and coupled with the base member 102 for utilization with the base assembly 100. For example, the lip of the mount 122 may extend perpendicular to the receiver member 120 in a bi-directional manner such that the lip of the mount prevents an object from sliding off of the base assembly 100 whether the base support 106 is in a first orientation, in which an object is being supported by the first side 140 of the receiver member 120, or the base support 106 is inverted from the first orientation to a second orientation, in which an object is being supported by the second side 142 of the receiver member 120. In the preferred embodiment, the first and second sides 140 and 142 of the receiver member 120 are integrally established in connection with the mount 122. In alternative embodiments, the receiver member 120 may be connected with the mount 122 through the use of fasteners, a compression lock system, a latch system, a friction fit system, and the like.

In exemplary embodiments, the base member 102 has a generally horizontal flat surface and is formed of a material suitable for maintaining the connective stability of the universal mobile base assembly 100 when the universal mobile base assembly 100 is supporting a heavy object, such as a table saw. In an exemplary embodiment, the base member 102 is a sheet of plywood. Alternatively, the base member 102 may be formed using various materials, such as other types of wood, composite materials, metals, and the like. The material forming the base member 102 should be such that it allows the base member 102 to be coupled with the base supports (104 through 110).

The size and shape of the base member 102 may be determined by a user so that the base member 102 allows the universal mobile base assembly 100 to accommodate the footprint dimensions of an object being supported by the base assembly 100. A user may either acquire or configure a base member 102 having the desired size and shape. For example, a user may wish to utilize the base assembly 100 for transporting a table saw. The user may then either acquire a base member 102 having a size and shape suitable for accommodating the footprint dimensions of the table saw, or the user may configure (i.e.—cut) the base member, such as a sheet of plywood, to the desired dimensions. The user may then couple the base member 102 with the base supports and utilize the universal mobile base assembly 100 for transporting the table saw.

In a current embodiment, the receiver member 120 of the base support 106 further includes a first fastening assembly 150 and a second fastening assembly 160. The first fastening assembly 150 is defined by a first fastening point 152, disposed upon the first side 140 of the receiver member 120, and a second fastening point 154, disposed upon the second side 142 of the receiver member 120. The second fastening assembly 160 is defined by a third fastening point 162, disposed upon the first side 140 of the receiver member 120, and a fourth fastening point 164, disposed upon the second side 142 of the receiver member 120. Further, the first (150) and second (160) fastening assemblies are established with their fastening points vertically aligned with respect to one another. For instance, the first fastening point 152 of the first fastening assembly 150 is in vertical alignment with the second fastening point 154 of the first fastening assembly 150. In the exemplary embodiment, the first, second, third and fourth fastening points (152, 154, 162 and 164) are apertures disposed through the first (140) and second (142) sides of the receiver member 120.

The configuration and vertical alignment of the fastening apertures (152, 154, 162 and 164) of the fastening assemblies (150, 160) enables the use of fasteners 116 and 118. In a preferred embodiment, fasteners 116 and 118 are bolts which may each be engaged through the fastening apertures and secured in place through the use of a nut. It is contemplated that various alternative fasteners, such as pins, screws, clips, and the like, may be employed with the fastening assemblies 150 and 160 of the present invention. In operation it is understood that the fastening assemblies (150, 160) may allow the user of the base assembly 100 to pre-drill the base member 102, engage the fasteners through the base member 102, and couple the base member 102 with the base support 106. In an exemplary embodiment, the receiver member 120 is formed of a deformable material for allowing the receiver member 120 to better couple with the base member 102 when the base member 102 is secured within the receiver member 120 by one or more fasteners. In additional embodiments, the receiver member 120 of the base assembly 100 may not include a slot 144, but rather, may be configured so that the base member 102 couples directly with the base support 106.

Through use of the fastening assemblies (150, 160) described above, the user's ability to easily adapt the base assembly 100 to differently-sized objects to be transported may be increased through the simple replacement of the base member 102. The replacement only requires the simple removal of fasteners (112-118 and 320-326). In alternative embodiments, the fastening assemblies (150, 160) may be enabled with snap lock systems, compression lock systems, friction fit systems, and the like. It is contemplated that various systems and fastening assembly configurations may be employed to couple the base supports with the base member 102. In further embodiments, the base member 102 may be secured with the base support 106 via one or more fasteners engaged through the mount 122. It is further contemplated that any of the various systems and fastening assembly configurations utilized for coupling the base supports with the base member may allow for an increase in the ease of adapting the base assembly 100 to variously-sized object footprints.

In an exemplary embodiment, each of the base supports are configured with one or more wheel members 136 for enabling the mobility of the base assembly 100. The wheel members 136 may have various configurations and may be established using a variety of devices, such as a roller, casters and the like. The wheel members 136 may or may not be the same and/or may or may not be established in the same manner for each base support 106. In the illustrated embodiment, the first and second base supports 104 and 106 each include a bracket 128 disposed on the second side 126 of the mount 122 for establishing the wheel member 136. In an exemplary embodiment, the connection of the bracket 128 with the second side 126 of the mount 122 is an integral connection. In alternative embodiments, the bracket 128 may be connected with the mount 122 using various fastening assemblies. For instance, fasteners, such as bolts, screws, clips, pins, and the like, may be employed to connect the bracket 128 with the mount 122. Alternatively, the bracket 128 may connect with the mount 122 using a latch system, compression lock system, friction fit system, and the like. The bracket 128 enables the establishment of an axle member 130, the axle member having a first end 132, which connects with the bracket 128 and a second end 134, which connects with the mount 122. The axle member 130 further couples a wheel member 136 with the bracket 128 and mount 122 by inserting through the axle receiver 137 disposed through the wheel member 136.

The use of alternative connection technologies, as described above, for connecting the bracket 128 with the mount 122 may enable the universal mobile base assembly 100 to employ differently configured brackets which may accommodate differently-sized wheel members 136. The ability to employ differently sized wheel members 136 may enable the universal mobile base assembly 100 to operate more effectively in different environments. For instance, where the user desires to employ the universal mobile base assembly 100 on flat even surfaces, wheel members 136 with smaller diameters, such as the casters of the current embodiment may be preferred. However, in an environment with uneven or rough surfaces, the use of larger diameter wheel members 136 may be advantageous. The size of wheel member 136 employed may vary as contemplated by those of ordinary skill in the art.

In the illustrated embodiment, the third and fourth base supports 108 and 110 establish a wheel member 250 as part of a wheel assembly 220. The following description of the fourth base support 110 is intended to encompass and serve as a description for the third base support 108. A first side 212 of the mount 210 is connected with the receiver member 202. The second side 214 of the mount 210 includes an arm bracket 222 having a first arm 224 and a second arm 226 for coupling with a wheel assembly 220. It is contemplated that the arm bracket 222 may include a plate to which the first 224 and second 226 arms are connected. In a preferred embodiment, the arm bracket 222 is integrally connected with the second side 214 of the mount 210. It is contemplated that the connection of the arm bracket 222 with the mount 210 may be established using various fastening/securing technologies. For example, various fasteners, such as bolts, screws, pins, clips, and the like, may be employed to couple the arm bracket 222 with the mount 210. Alternatively, a latch system, compression lock system, friction fit system, and the like may be employed to couple the arm bracket 222 with the mount 210.

In the current embodiment, the first arm 224 and second arm 226 are established with a defined spacing between them. The defined spacing allows for a wheel mount 230 of a wheel assembly 220 to be positioned between the first 224 and second 226 arm. In a preferred embodiment, the wheel mount 230 is coupled with the first arm 224 via a fastener 236 which couples through the first arm 224 and through a first side of the wheel mount 230. The wheel mount 230 is further coupled with the second arm 226 via a fastener 238 which couples through the second arm 226 and through a second side of the wheel mount 230. In further embodiments, a first end of the wheel mount 230 may be coupled with the mount 210. It is understood that the coupling of the wheel mount 230 with the first arm 224, second arm 226, and the mount 210 may be enabled using various fastening/securing technologies. Further, the coupling may employ the use of hinges, joints, and the like to enable an adjustable coupling. The current embodiment exemplifies the use of a bolt to couple the first 224 and second 226 arms with the wheel mount 230. Alternatively, various fasteners, such as screws, clips, pins, and the like may be employed, or various fastening systems, such as a latch system, compression lock system, friction fit system, and the like may be employed.

The wheel mount 230 may be further connected with a first wheel arm 244 and a second wheel arm 246 of the wheel assembly 220, whereby the coupling of a wheel member 250 with the wheel mount 230, via an axle member 248, is enabled. The wheel member 250 may be variously configured to meet the desired needs of a consumer or manufacturer. In the illustrated embodiment, the wheel member 250 is a caster, which swivels for enabling maneuverability (i.e.—ability to make sharp turns) of the base assembly 100. It is understood that the wheel member 250, which also exemplifies the wheel member employed with the third base support 108, enables the mobility of the universal mobile base assembly 100 in conjunction with the wheel members 136 employed with the first and second base supports 104 and 106. It is contemplated that the wheel members 250 employed with the third 108 and fourth 110 base supports may be the same as or different from the wheel members 136 employed with the first 104 and second 106 base supports.

In an exemplary embodiment, further coupled with the second end 242 of the wheel mount 230 and also pivotally coupled with the first arm 224 and second arm 226 of the arm bracket 222 is a foot pedal 262 of the wheel assembly 220. The foot pedal 262 includes a lower surface 260. In the current embodiment, the first arm 224 is connected with the foot pedal 262 by a fastener 266 and the second arm 226 is connected with the foot pedal 262 by a fastener 268. The fasteners 266 and 268 are bolts which may be engaged with a nut to secure the coupling of the first and second arm with the foot pedal 260. It is contemplated that the coupling of the foot pedal 262 with the first arm 224, second arm 226 and wheel mount 230 may be accomplished using a variety of fasteners and/or fastening systems, as previously described throughout the instant specification. The foot pedal 262 may assist the user in enabling and/or disabling the mobility of the universal mobile base assembly 100 as will be discussed below.

The base assembly 100 may also include one or more support assemblies 280, each support assembly having a support mount 282 connected with the base support 110. In the illustrated embodiment, the support mount 282 enables the coupling of a support member 284 with the mount 210 of the base support 110. In a preferred embodiment, the support member 284 is a threaded rod, which is connected on one end with a support pad 286. The support pad 286 is enabled to adjustably engage with a surface upon which the universal mobile base assembly 100 is seated. The adjustable engagement capability of the support pad 286 is enabled by the support member 284 being capable of adjusting relative to the surface through threaded engagement with the support mount 282. In an exemplary embodiment, the support mount 282 is an integral part of the second side 214 of the mount 210. However, it is further contemplated that in other embodiments the support mount 282 may couple to the base support 110 via a variety of other mechanisms such as a tongue and groove assembly, latch system, compression lock system, and the like. The threaded engagement of the support member 284 with the support mount 282 enables the support member 284 to be rotated in either a clockwise or counter-clockwise direction, thereby raising or lowering the support pad 286 relative to the surface. It is understood that the support assembly 280 may be established using a variety of technologies as contemplated by those of ordinary skill in the art.

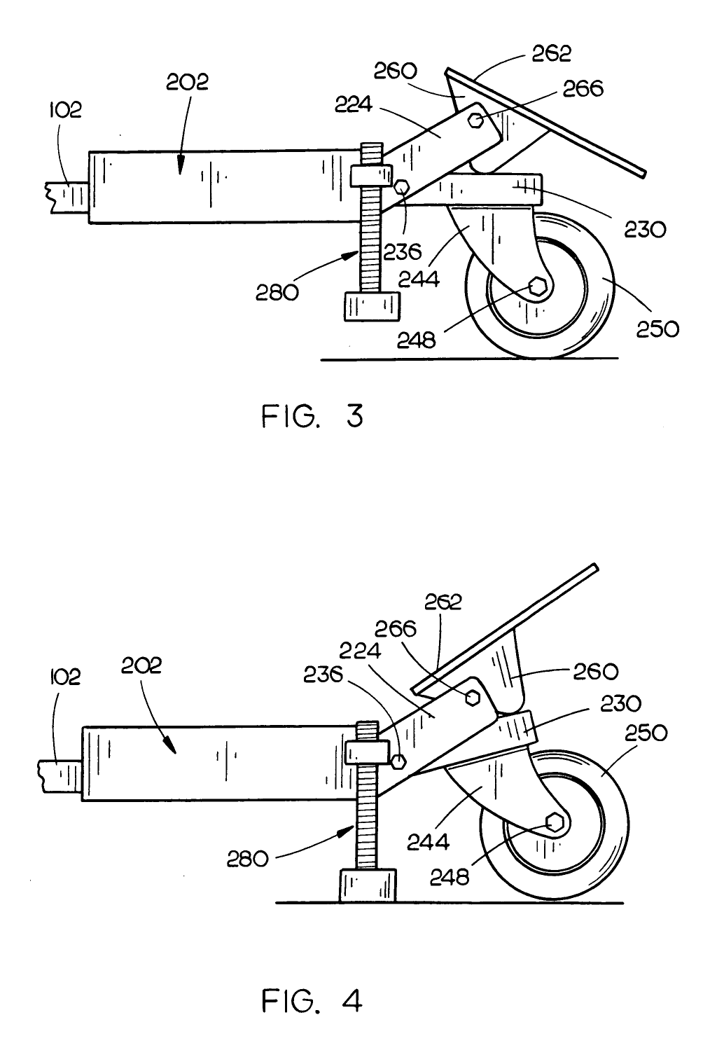

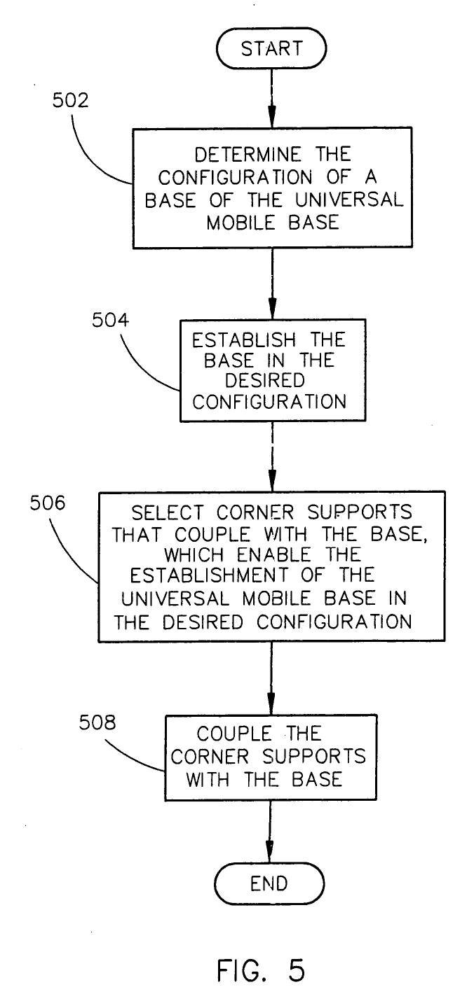

In the illustrated embodiment, the foot pedal 262 is enabled as a two-position foot pedal to raise and lower the wheel member 250 relative to the base member 102 and a surface on which the universal mobile base assembly 100 is seated. (as shown in FIGS. 3 and 4). This movement may also enable the raising and lowering of the support pad 286. Thus, when the foot pedal 262 is in a first position (as shown in FIG. 3), the lower surface 260 of the foot pedal 262 contacts the wheel mount 230 forcing the wheel mount 230 downward towards the surface. The downward movement of the wheel mount forces the base support 202, the base member 102, and the support assembly 280 to move upward in a direction away from the surface, thereby allowing the wheel member 250 of the universal mobile base assembly 100 to be in contact with the surface. In this position, the universal mobile base assembly 100 may be moved on its wheels 250 along the surface. When the foot pedal 262 is in a second position (as shown in FIG. 4), the wheel member 250 is positioned away from the surface and the universal mobile base assembly 100 is supported by the support assembly 280, the support assembly 280 being in contact with the surface, thereby inhibiting the movement of the universal mobile base assembly 100 along the surface. It is understood that various assemblies, such as a cammed lever assembly, are contemplated by those of ordinary skill in the art for implementation in engaging the wheel members 250 and/or the support assembly 280 with a work surface.

It is further contemplated that the universal mobile base assembly 100 may include one or more stop assemblies for further defining user operation of the present invention. The stop assemblies may allow a user to selectably determine the rotational capabilities of one or more of the wheel members 136, 250 of the universal mobile base assembly 100. For instance, the wheel members 250 of the third 108 and fourth 110 base supports of the illustrated embodiment may each include a stop assembly, such as a caster swivel lock assembly for preventing swiveling of the wheel member and/or for locking the wheel member 250.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A mobile base assembly for receiving an object, comprising:
a generally planar base member;
a plurality of base supports, each base support of the plurality of base supports including a receiver member defining a single slot for receiving at least a portion of the base member; and
at least one wheel member connected with each base support included in the plurality of base supports for transporting the mobile base assembly,
wherein dimensions of the base member are approximate to footprint dimensions of an object being supported by the mobile base assembly.

2. A mobile base assembly as claimed in claim 1, wherein the slot is configured for receiving a corner portion of a generally rectilinear-shaped, planar base member.

3. A mobile base assembly as claimed in claim 1, wherein the slot is configured for receiving a portion of a generally planar base member having a thickness of less than one inch.

4. A mobile base assembly as claimed in claim 1, wherein the wheel member of at least one of the base supports included in the plurality of base supports is pivotable to obtain a first position in which the wheel member extends a first distance from the base support and a second position in which the wheel member extends a second distance from the base support, the first distance being a different value than the second distance.

5. A mobile base assembly as claimed in claim 1, further comprising at least one support assembly member connected to a base support included in the plurality of base supports for at least partially supporting the mobile base assembly in a fixed position on a support surface.

6. A mobile base assembly as claimed in claim 1, wherein each base support included in the plurality of base supports includes a lip portion for at least partially retaining an object being supported by the mobile base assembly.

7. A mobile base assembly as claimed in claim 1, wherein at least one of the base supports included in the plurality of base supports includes a swiveling wheel member for allowing maneuverability of the base assembly during transport.

8. A kit for use with a generally planar base member, the kit and the base member to be assembled into a mobile base assembly, the kit comprising:
a plurality of base supports, each base support of the plurality of base supports including a receiver member defining a single slot for receiving at least a portion of a base member; and
at least one wheel member coupled with each base support for transporting the mobile base assembly.

9. A kit as claimed in claim 8, wherein the slot is configured for receiving a corner portion of a generally rectilinear-shaped, planar base member.

10. A kit as claimed in claim 8, wherein the slot is configured for receiving a portion of a generally planar base member having a thickness of less than one inch.

11. A kit as claimed in claim 8, wherein the wheel member of at least one of the base supports included in the plurality of base supports is pivotable to obtain a first position in which the wheel member extends a first distance from the base support and a second position in which the wheel member extends a second distance from the base support, the first distance being a different value than the second distance.

12. A kit as claimed in claim 8, further comprising at least one support assembly member connected to a base support included in the plurality of base supports for at least partially supporting the mobile base assembly in a fixed position on a support surface.

13. A kit as claimed in claim 8, wherein each base support included in the plurality of base supports includes a lip portion for at least partially retaining an object being supported by the mobile base assembly.

14. A kit as claimed in claim 8, wherein at least one of the base supports included in the plurality of base supports includes a swiveling wheel member for allowing maneuverability of the base assembly during transport.

15. A kit as claimed in claim 8, further comprising at least one shim member for aiding in securing the generally planar base member within the receiver member.

16. A mobile base assembly for receiving an object, comprising:
a generally planar base member;
a plurality of base supports, each base support included in the plurality of base supports including means for receiving at least a portion of the generally planar base member; and
means for transporting the mobile base assembly,
wherein dimensions of the base member are approximate to footprint dimensions of an object being supported by the mobile base assembly.

17. A mobile base assembly as claimed in claim 16, wherein a base support included in the plurality of base supports includes a means for at least partially retaining an object being supported by the mobile base assembly.

18. A mobile base assembly as claimed in claim 16, further comprising securing means for securing the base supports and the generally planar base member.

19. A mobile base assembly as claimed in claim 16, further comprising means for at least partially supporting the mobile base assembly in a fixed position on a support surface.

20. A mobile base assembly as claimed in claim 16, further comprising means for selectively establishing the base assembly in a fixed position on a support surface and in a non-fixed position on the support surface.
